(19) United States
(12) Patent Application Publication
(10) Pub. No.: US 2010/0332624 A1
(43) Pub. Date: Dec. 30, 2010

(54) INFORMATION PROCESSING APPARATUS FOR MANAGING ADDRESS BOOK DATA, CONTROL METHOD THEREFOR, AND STORAGE MEDIUM STORING CONTROL PROGRAM THEREFOR

(75) Inventor: Yoshihide Terao, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/820,472

(22) Filed: Jun. 22, 2010

(30) Foreign Application Priority Data
Jun. 30, 2009 (JP) 2009-155254

(51) Int. Cl. G06F 15/177

(52) U.S. Cl. 709/220

(57) ABSTRACT

An information processing apparatus that is capable of improving security by restricting improper registration of address book data. A registration unit registers a destination into an address book. A first determination unit determines whether the destination that is to be registered by the registration unit is a new destination. An addition unit adds identification information that shows a new destination to the address book when determined as a new destination by the first determination unit. A requirement unit requires transmitting and registering the address book data to another information processing apparatus.

### BACKGROUND OF THE INVENTION

1. Field of the Invention

The present invention relates to an information processing apparatus for managing address book data, a control method therefor, and a storage medium storing control program therefor.

2. Description of the Related Art

Conventionally, an information processing apparatus like a digital multifunctional peripheral device converts a scanned document into electronic form, and transmits it. A transmitting destination is designated through an input device such as an operation panel or is designated by selecting from an address book that is registered into an HDD in the information processing apparatus.

However, when a user is permitted to input a new destination through the input device, there is a problem of security that the user can easily convert a confidential document into electric form and transmit it to an exterior. Therefore, a function in which an administrator prohibits a user from designating a new destination that has been inputted by the user through the input device is generally used.

In recent years, a technique of synchronizing address books of a plurality of information processing apparatuses by distributing the newest address book data among the information processing apparatuses has been known as a technique of sharing the address book data among the information processing apparatuses.

For example, Japanese Laid-Open Patent Publication (Kokai) No. 2002-232585 (JP 2002-232585A) discloses a technique where an apparatus that receives an electric mail including destination information in the mail body detects a specific identifier corresponding to the destination information included in the mail body, and registers text information following the identifier into the address book as the destination information.

Moreover, Japanese Laid-Open Patent Publication (Kokai) No. 2007-081578 (JP 2007-081578A) discloses a technique of keeping access restrictions for respective users in order to improve security when the address book in which the access restrictions for the respective users are set is distributed.

However, the sharing of the address book among the information processing apparatuses causes the following problem when an information processing apparatus A permits a user to input a new destination and an information processing apparatus B prohibit a user from inputting a new destination.

Since the new destination inputted to the information processing apparatus A can be registered to the address book of the information processing apparatus B, the new destination can also be used in the information processing apparatus B. This causes a problem in security.

In the prior art, an access to a destination that has been already registered to the address book is restricted, but an access to a newly inputted destination is not restricted.

### SUMMARY OF THE INVENTION

The present invention provides an information processing apparatus that is capable of improving security by restricting improper registration of address book data.

Accordingly, a first aspect of the present invention provides an information processing apparatus comprising a registration unit adapted to register a destination into an address book, a first determination unit adapted to determine whether the destination that is to be registered by the registration unit is a new destination, an addition unit adapted to add identification information that shows a new destination to the address book when determined as a new destination by the first determination unit, and a requirement unit adapted to require transmitting and registering the address book data to another information processing apparatus.

Accordingly, a second aspect of the present invention provides an information processing apparatus comprising a registration unit adapted to register a destination into an address book, a receiving unit adapted to receive address book data from another information processing apparatus, a second determination unit adapted to determine whether registration of a new destination is restricted when registering the address book, and a third determination unit adapted to determine whether identification information that shows a new destination is added to the address book data received by the receiving unit, when the second determination unit determines that the registration of a new destination is restricted, wherein the registration unit registers the address book data, when the third determination unit determines that the identification information that shows a new destination is not added to the address book data concerned.

Accordingly, a third aspect of the present invention provides a control method for an information processing apparatus comprising a registration step of registering a destination into an address book, a first determination step of determining whether the destination that is to be registered in the registration step is a new destination, an addition step of adding identification information that shows a new destination to the address book when determined as a new destination in the first determination step, and a requirement step of requiring transmitting and registering the address book data to another information processing apparatus.

Accordingly, a fourth aspect of the present invention provides a control method for an information processing apparatus comprising a registration step of registering a destination into an address book, a receiving step of receiving address book data from another information processing apparatus, a second determination step of determining whether registration of a new destination is restricted when registering the address book, and a third determination step of determining whether identification information that shows a new destination is added to the address book data received in the receiving step, when it is determined that the registration of a new destination is restricted in the second determination step, wherein the address book data is registered in the registration step, when it is determined that the identification information that shows a new destination is not added to the address book data concerned in the third determination step.

Accordingly, a fifth aspect of the present invention provides a computer-readable storage medium storing a control program executing a control method for an information processing apparatus, the control method comprising a registration step of registering a destination into an address book, a first determination step of determining whether the destination that is to be registered in the registration step is a new destination, an addition step of adding identification information that shows a new destination to the address book when dete nined as a new destination in the first determination step, and a requirement step of requiring transmitting and registering the address book data to another information processing apparatus.

Accordingly, a sixth aspect of the present invention provides a computer-readable storage medium storing a control program executing a control method for an information processing apparatus, the control method comprising a registration step of registering a destination into an address book, a receiving step of receiving address book data from another information processing apparatus, a second determination step of determining whether registration of a new destination is restricted when registering the address book, and a third determination step of determining whether identification information that shows a new destination is added to the address book data received in the receiving step, when it is determined that the registration of a new destination is restricted in the second determination step, wherein the address book data is registered in the registration step, when it is determined that the identification information that shows a new destination is not added to the address book data concerned in the third determination step.

According to the present invention, the security is improved by restricting improper registration of the address book data.

Further features of the present invention will become apparent from the following description of exemplary embodiments with reference to the attached drawings.

### BRIEF DESCRIPTION OF THE DRAWINGS

FIG. 1 is a configuration diagram showing an information processing system according to the embodiment of the present invention.

FIG. 2 is a block diagram schematically showing configurations of an electronic mail server and a file sharing server shown in FIG. 1.

FIG. 3 is a block diagram schematically showing a common configuration of an address book client and an address book server in FIG. 1.

FIG. 4 is a view showing a screen example displayed on an operation-display unit in FIG. 3 for directing transmission of a scan image.

FIG. 5 is a view showing a screen example displayed on the operation-display unit in FIG. 3 for restricting a new destination.

FIG. 6 is a view showing a screen example displayed on the operation-display unit in FIG. 3 for inputting a new destination.

FIG. 7 is a view showing a screen example registering an address book server.

FIG. 8 is a view showing a screen example of a local address book displayed on the operation-display unit in FIG. 3.

FIG. 9 is a view showing a screen example of a remote address book displayed on the operation-display unit in FIG. 3.

FIG. 10 is a view showing a screen example of a transmission history displayed on the operation-display unit in FIG. 3.

FIG. 11 is a view showing a screen example displayed on the operation-display unit in FIG. 3 for calling a transmission setting history by a call.

FIG. 12 is a view showing a screen example displayed on the operation-display unit in FIG. 3 for setting permission or prohibition of registration of the address book.

FIG. 13 is a flowchart showing procedures of a registration process that is executed by the address book client in FIG. 1 to register the address book data to the address book server.

FIG. 14 is a view showing data structure of the address book stored in the address book client in FIG. 3.

FIG. 15 is a view showing a screen example of a registration result of the address book displayed on the operation-display unit in FIG. 3.

FIG. 16 is a view showing a screen example of a registration result of the address book displayed on the operation-display unit in FIG. 3.

FIG. 17 is a view showing a screen example of a registration result of the address book displayed on the operation-display unit in FIG. 3.

FIG. 18 is a flowchart showing procedures of a registration process that is executed by the address book server to register the address book data when the address book data is registered to the address book server from the address book client in FIG. 1.

### DESCRIPTION OF THE EMBODIMENTS

Hereafter, embodiments according to the present invention will be described in detail with reference to the drawings.

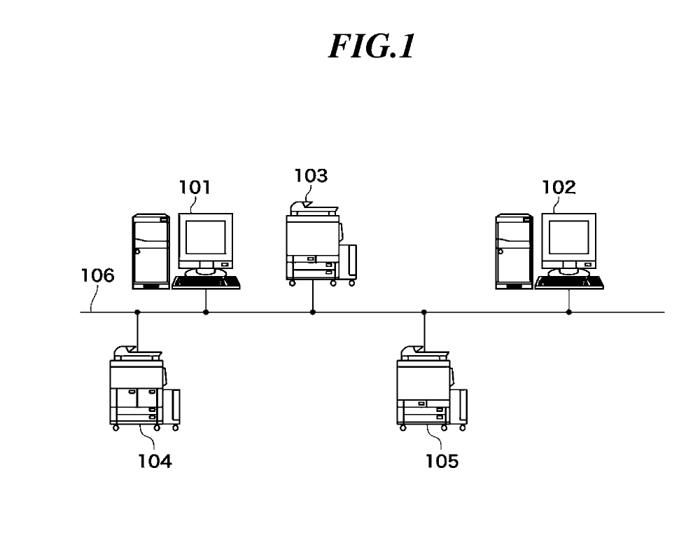

FIG. 1 is a configuration diagram showing an information processing system according to the embodiment of the present invention.

The information processing system in FIG. 1 is configured by an electronic mail server 101, a file sharing server 102, a first address book client 103, a second address book client 104, and an address book server 105, which are connected through a network 106.

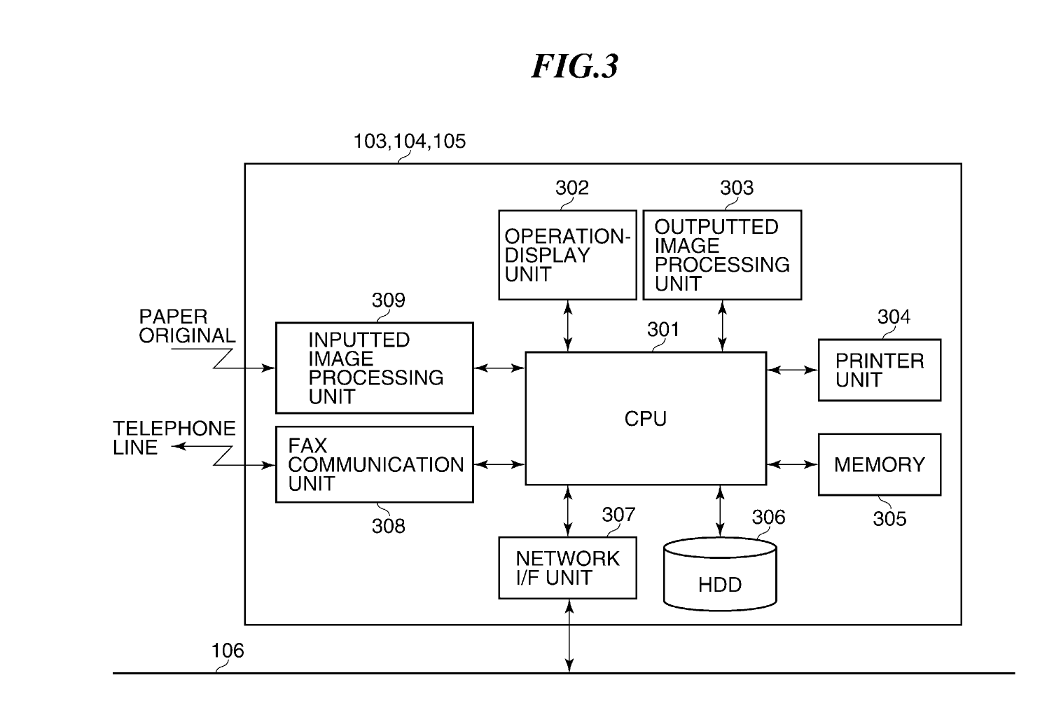

The first address book client 103 and the second address book client 104 are able to refer to an address book registered in an HDD 306 (see FIG. 3 showing a common configuration of the clients and the server) of the address book server 105 via the network 106.

Address book data registered in the HDD 306 of the first address book client 103 and the second address book client 104 can be registered into the address book server 105 via the network 106.

The first address book client 103, the second address book client 104, and the address book server 105 are multifunctional peripheral devices (image processing apparatuses). Therefore, they have a copying function to copy a paper document, and a transmitting function to transmit electronic data that is converted from a paper document to a desired destination as an electronic mail through the electronic mail server 101, or to a folder on the file sharing server 102. It should be noted that the multifunctional peripheral devices in this embodiment are examples of the image processing apparatus, and the present invention may be applied to image processing apparatuses, for example, a scanner, a facsimile, a copier, a printer, etc. other than the multifunctional peripheral device.

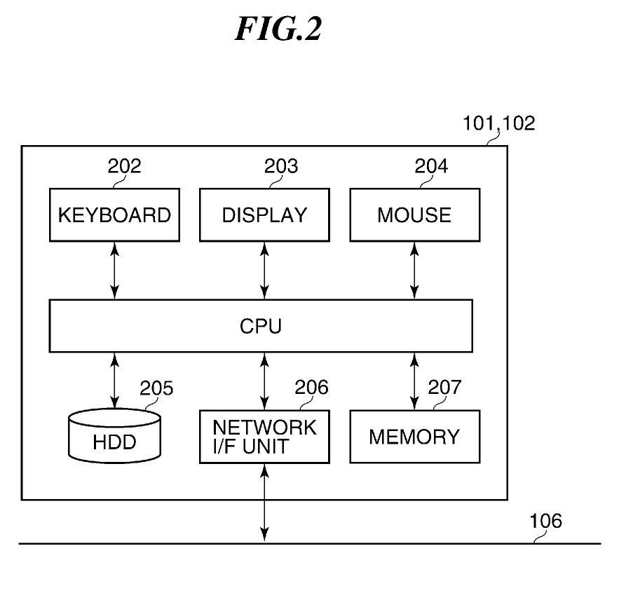

FIG. 2 is a block diagram schematically showing configurations of the electronic mail server 101 and the file sharing server 102 shown in FIG. 1. Hereafter, the configuration of the electronic mail server 101 will be described as a representative.

The electronic mail server 101 is provided with a CPU 201 that performs data processing (manages an entire control), a keyboard 202 by which a user inputs data, a display 203 that displays a computer screen, and a mouse 204 by which the user operates a mouse cursor.

Moreover, the electronic mail server 101 is provided with an HDD 205 that stores data, a network I/F unit 206 that communicates with the network 106, and a memory 207 that stores data temporarily.

FIG. 3 is a block diagram schematically showing a common configuration of the first address book client 103, the second address book client 104 and the address book server 105 in FIG. 1. Hereafter, the configuration of the second address book client 104 will be described as a representative.

The second address book client 104 is provided with a CPU 301 that performs data processing, an operation-display unit 302 that displays information to a user and receives an operation from the user, and an outputted image processing unit 303 that converts an inputted paper original into electronic data and applies image processing to the electronic data.

Moreover, the second address book client 104 is provided with a printer unit 304 that prints print data and raster image data on a paper, a memory 305 that stores data temporarily, and the HDD 306 that stores image data.

Furthermore, the second address book client 104 is provided with a network I/F unit 307 that communicates with the network 106, a FAX communication unit 308 that carries out FAX communication, and an inputted image processing unit 309 that scans a paper original.

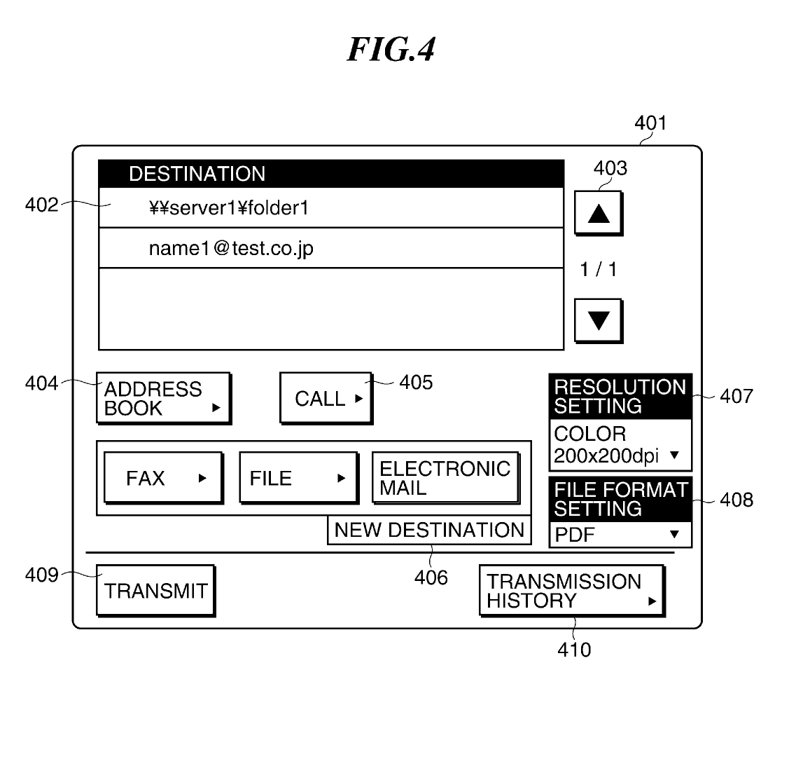

FIG. 4 is a view showing a screen 401 for transmitting the document scanned by the first address book client 103 or the second address book client 104 in FIG. 3.

The screen 401 is displayed on the operation-display unit 302 in FIG. 3. When pushing an address book button 404, a user can refer to an address book stored in the HDD 306 or an address book registered in the address book server 105, and can select a transmitting destination.

The selected transmitting destination is displayed in a selection destination display unit 402. When a plurality of selected transmitting destinations cannot be displayed within one screen, the destinations can be scrolled and displayed by pushing a scroll button 403.

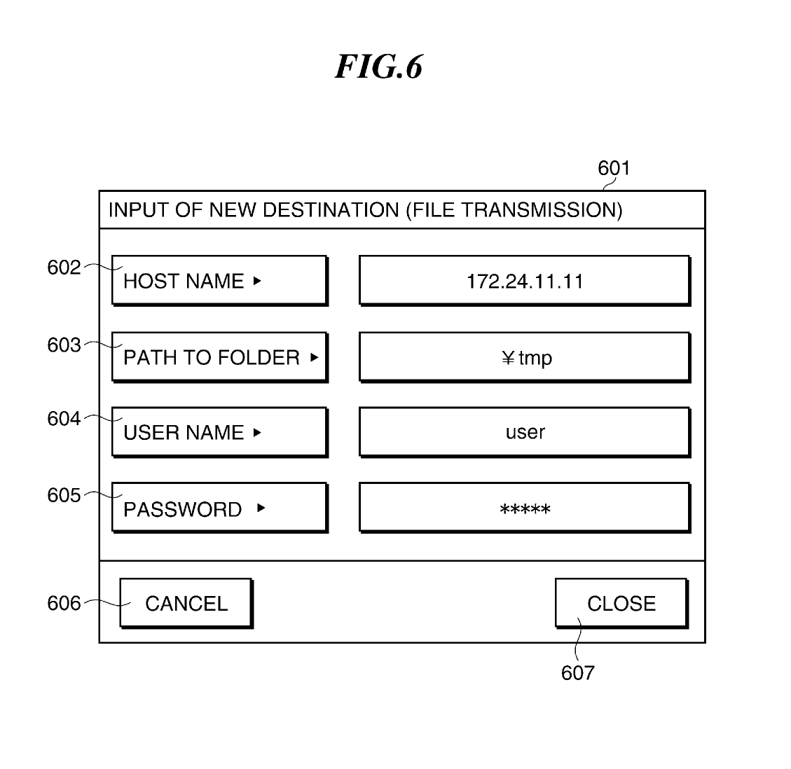

When pushing a FAX button, a file button, or an electronic mail button displayed in a new destination area 406, a screen 601 as shown in FIG. 6 mentioned later will be displayed. When necessary information is inputted in the screen 601, a transmission to a destination that is not stored in the address book becomes possible. That is, the address book client of this embodiment can designate a transmitting destination by two kinds of methods. One is the method of referring to the address book and selecting a transmitting destination that is registered therein. The other method is that a user directly inputs a transmitting destination through the operation-display unit without using the address book. As described later, a certain setting of the address book client prohibits a user from inputting a new transmitting destination for the purpose of managing designatable destinations by an administrator. In that case, the address book client has only one method of selecting a transmitting destination from among the transmitting destinations registered in the address book for designating the transmitting destination.

Any resolution (200 dpi. etc.) can be set in a resolution setting screen 407, and any file format (PDF, JPEG, etc.) can be set up in a file-format setting screen 408.

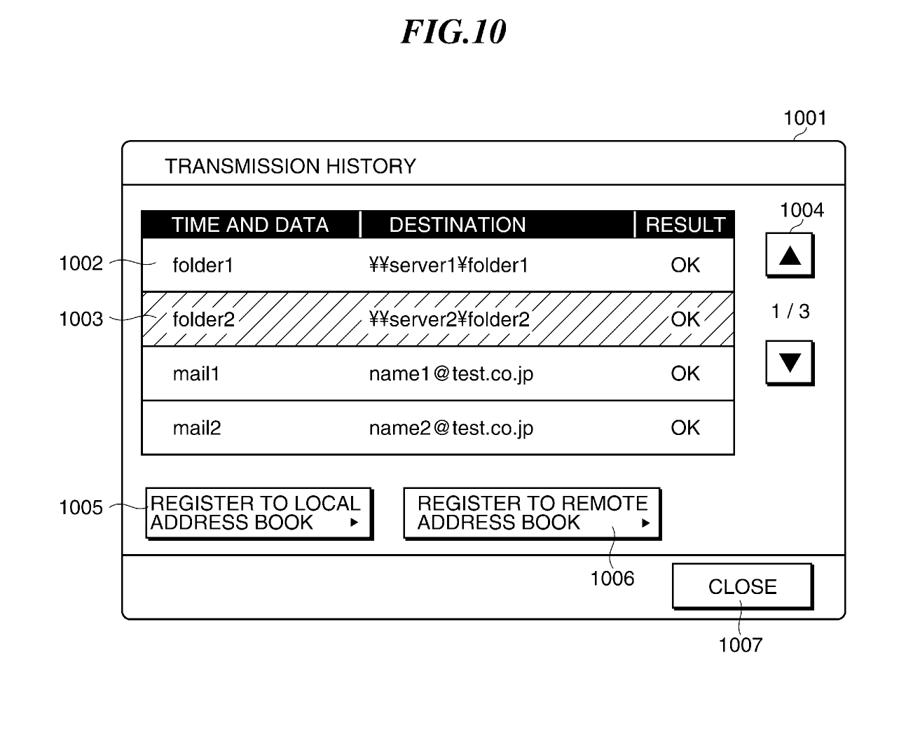

When pushing a transmission button 409, a scan and transmission of an original are started. When pushing a transmission history button 410, information about transmitted results can be displayed on a screen 1001 as shown in FIG. 10 described later. A reference numeral 405 represents a call button.

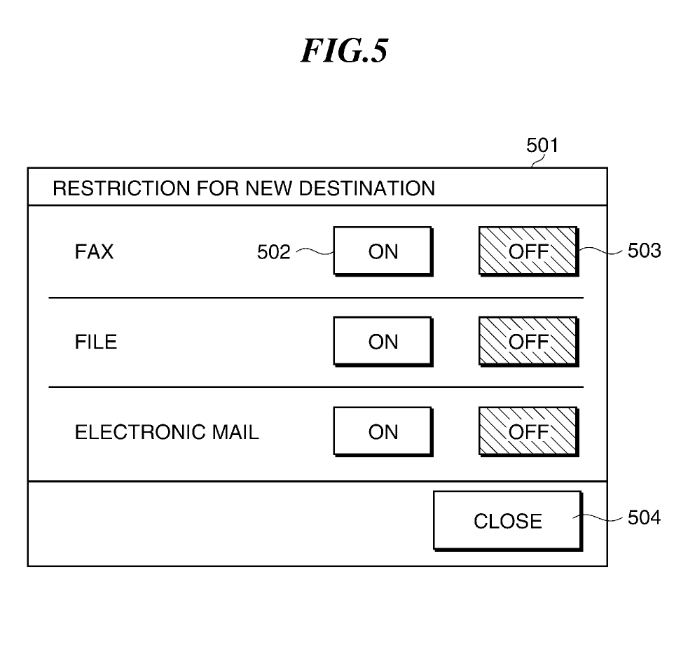

FIG. 5 is a view showing a screen 501 for restricting an input of a new destination that is executed by selecting one of the FAX button, the file button, and the electronic mail button displayed in the new destination area 406 in FIG. 4.

In the screen 501, “ON” (restrict) and “OFF” (not restrict) of the restriction can be switched for the respective transmitting protocols. For example, a push of the ON button 502 for the FAX disables the FAX button displayed in the new destination area 406, and an input of a new destination will be prohibited. A push of a closed button 504 confirms settings. A reference numeral 503 represents an OFF button.

FIG. 6 is a view showing a screen 601 for inputting information about a transmitting destination displayed on the operation-display unit 302, when the file button in the new destination area 406 in FIG. 4 is pushed.

Necessary information is inputted after pushing each of a host name button 602, a path-to-folder button 603, A user name button 604, and a password button 605. A push of a cancel button 606 cancels settings and a push of a close button 607 confirms the settings.

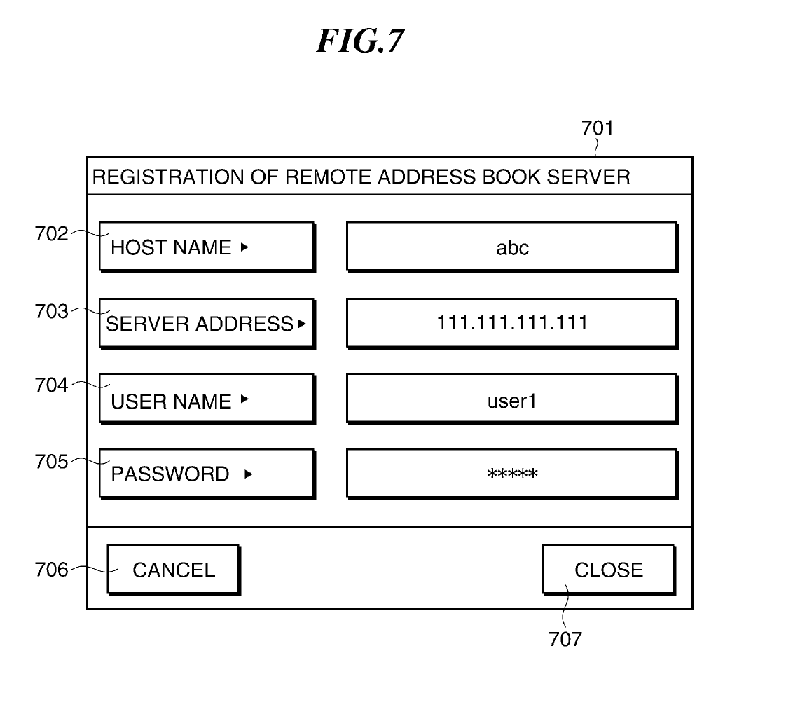

FIG. 7 is a view showing a screen 701 displayed on the operation-display unit 302 for registering the address book server 105 in FIG. 1 into the first address book client 103 and the second address book client 104.

In the screen 701 in FIG. 7, information required to connect to the address book server 105 is inputted after pushing each of a server name button 702, a server address button 703, a user name button 704, and a password button 705. A push of a cancel button 706 cancels settings and a push of a close button 707 confirms the settings.

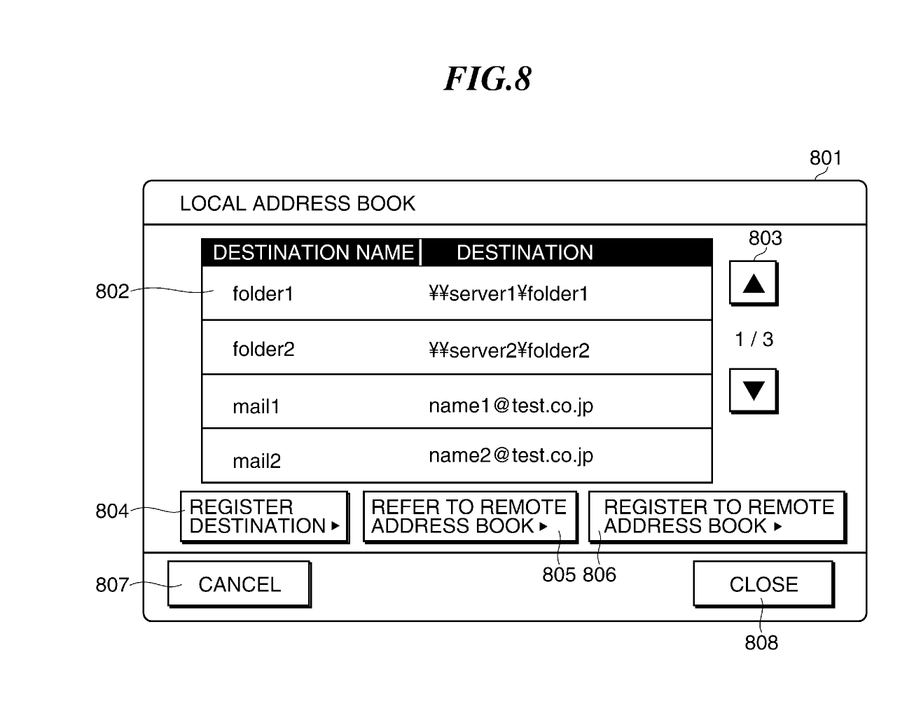

FIG. 8 is a view showing a screen 801 displayed on the operation-display unit 302, when the address book button 404 in FIG. 4 is pushed.

In the screen 801 of FIG. 8, a local address book can be displayed, selected, and registered, and a remote address book can be displayed, selected, and registered.

The address book data stored in the HDD 306 is displayed in an address book display area 802. When pushing a destination registering button 804, any destinations can be inputted and registered.

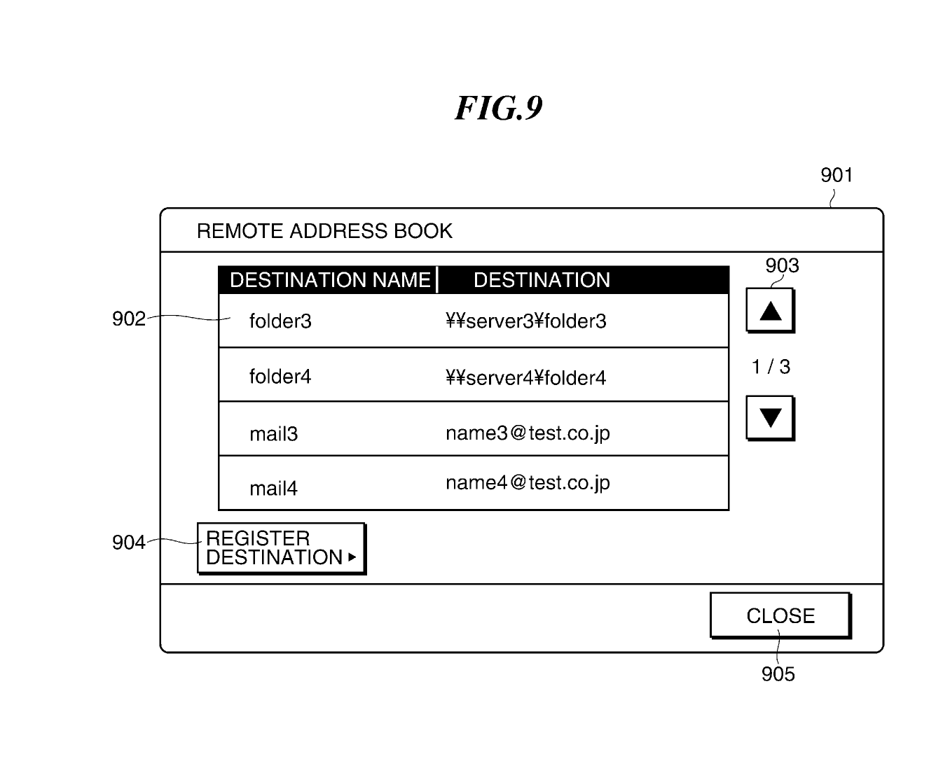

When pushing a reference-to-remote-address-book button 805, the address book client is connected to the address book server 105 set up in FIG. 7 through the network 106, and displays the address book data stored in the HDD 306 of the address book server 105. The result is displayed in a screen 901 in FIG. 9 mentioned later.

When pushing a registration-to-remote-address-book button 806, the address book client becomes possible to register the destination selected in the address book display area 802 into the address book of the address book server 105. A push of a cancel button 807 cancels settings, and a push of a close button 808 confirms the settings. A reference numeral 803 represents a scroll button.

FIG. 9 is a view showing a screen 901 displayed on the operation-display unit 302, when the reference-to-remote-address-book button 805 in FIG. 8 is pushed.

The address book data stored in the HDD 306 of the address book server 105 can be displayed, selected, and registered by operations from the operation-display unit 302 of the first address book client 103 or the second address book client 104.

When the address book cannot be displayed within one screen, the address book can be scrolled and displayed by pushing a scroll button 903. When pushing a destination registering button 904, any destination can be inputted and registered into the address book stored in the HDD 306 of the address book server 105. When pushing a close button 904, the screen 901 will be closed and the screen 801 for the local address book will be displayed again. A reference numeral 902 represents an address book display area.

FIG. 10 is a view showing a screen 1001 displayed on the operation-display unit 302, when the transmission history button 410 in FIG. 4 is pushed.

The transmitted result is displayed in an address book display area 1002. In the address book display area 1002, time and date of the transmission, the transmitting destination, the result, etc. are displayed. When the history cannot be displayed within one screen, the history can be scrolled and displayed by pushing a scroll button 1004.

When the transmitted result is selected (an area 1003) and a registration-to-local-address-book button 1005 or a registration-to-remote-address-book button 1006 is pushed, the destination selected by the area 1003 becomes possible to be registered into each address book. When pushing a close button 1007, the screen 1001 will be closed and the screen 401 will be displayed again.

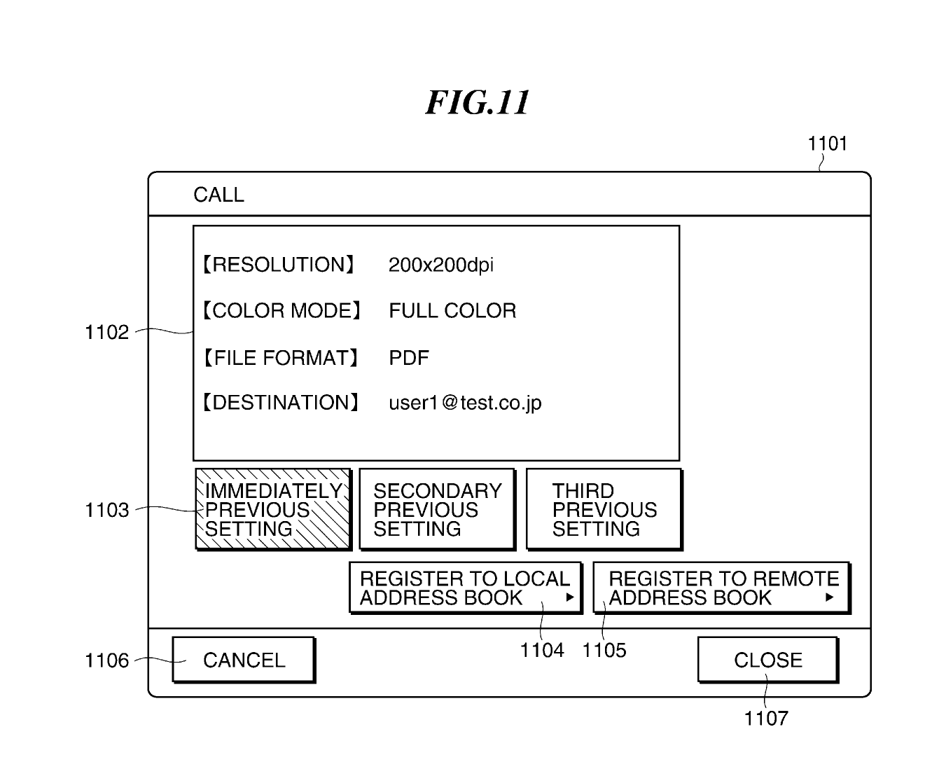

FIG. 11 is a view showing a screen 1101 displayed on the operation-display unit 302, when the call button 405 in the screen 401 in FIG. 4 is pushed.

The screen 1101 is provided with a display area 1102 for calling the transmitting setting resolution, the file format, the transmitting destination, etc. of the transmission performed in the past. When pushing the history button 1103, the immediately previous setting, the secondary previous setting, and the third previous setting can be called.

The transmitting destination called by the history button 1103 becomes possible to be registered into each address book when a registration-to-local-address-book button 1104 or a registration-to-remote-address-book button 1105 will be pushed.

When pushing a cancel button 1106, the setting called by the call button 405 is canceled, and the screen 401 is displayed again. When pushing a close button 1107, the setting by the call button 405 is called, and the screen 401 is displayed again.

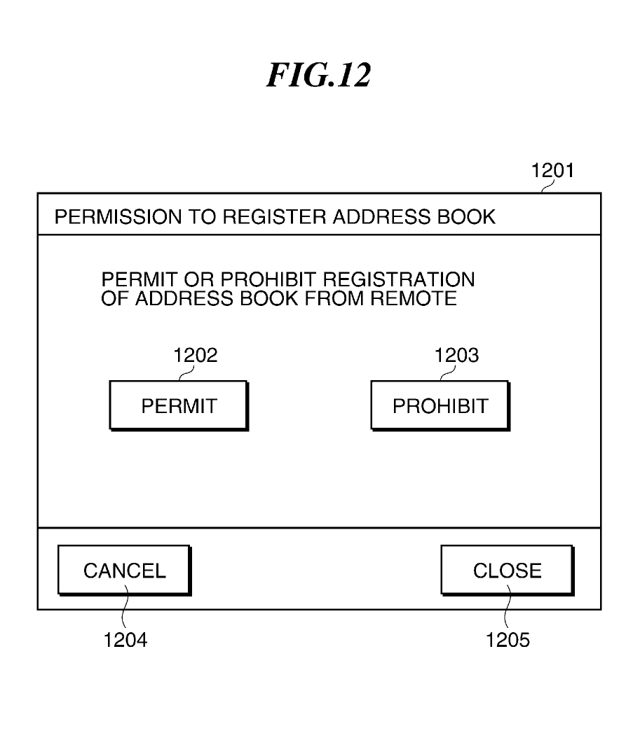

FIG. 12 is a view showing a screen 1201 displayed on the operation-display unit 302 for setting permission or prohibition of registration of the address book data from the first address book client 103 or the second address book client 104 into the address book of the address book server 105 in FIG. 1.

A push of a permission button 1202 allows registration of the address book data of the first address book client 103 or the second address book client 104 into the address book of the address book server 105.

A push of a prohibition button 1203 prohibits registration of the address book data of the first address book client 103 or the second address book client 104 into the address book of the address book server 105. Reference numerals 1204 and 1205 represent a cancel button and a close button, respectively.

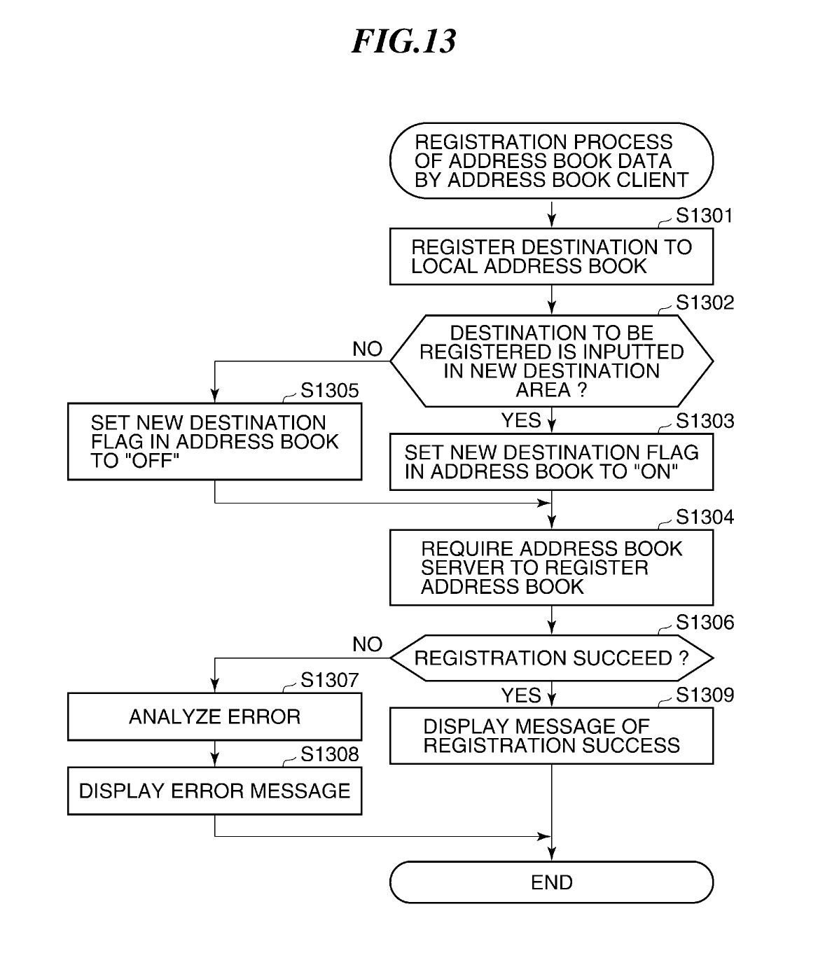

FIG. 13 is a flowchart showing procedures of a registration process that is executed by the first address book client 103 or the second address book client 104 in FIG. 1 to register the address book data to the address book server 105.

The registration process of the address book data by the address book client is executed by the CPU in FIG. 2 or FIG. 3 according to a registration processing recipe of the address book data by the address book client that is a registration processing program of a corresponding address book data.

First, the address book client (a first information processing apparatus) registers the destination to the address book (the local address book) based on the input of the button 804 in the screen 801, the button 1005 in the screen 1001, or the button 1104 in the screen 1101 (step S1301).

In this case, the address book client determines whether the destination that is to be registered is a destination inputted in the new destination area 406 (step S1302). This determination process is an example of a first determination unit in this embodiment.

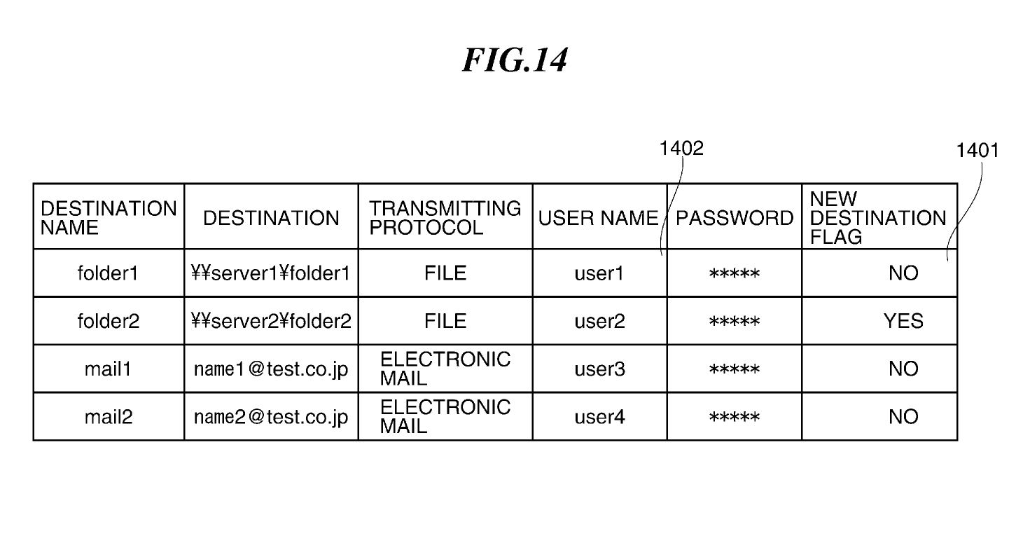

If the destination has been inputted in the new destination area 406, the address book client registers the destination to the address book of the address book client by adding information (identification information) that shows a new destination to the address book data as shown in FIG. 14 (step S1303). The destination represented by a flag of “YES” in FIG. 14 is a new destination. The destination represented by a flag of “NO” is not a new destination.

FIG. 14 shows a data structure of the address book data that is currently held by the address book client. The flag 1401 that shows whether the destination has been inputted in the new destination input area 406 or not, and data 1402 that shows a transmitting protocol of the destination are added other than the destination, the user name, and the password.

When the destination does not have been inputted in the new destination area 406, that is, when it has been inputted by the destination registering button 804 in the screen 801, the address book client adds the information that it is not a new destination to the address book data shown in FIG. 14 (step S1305). Then, the data is registered into the address book of the address book client.

Next, the address book client requires the address book server (a second information processing apparatus) 105 to register the address book data (step S1304).

This registration requirement is executed by pushing the button 806 in the screen 801, the button 1006 in the screen 1001, or the button 1105 in the screen 1101.

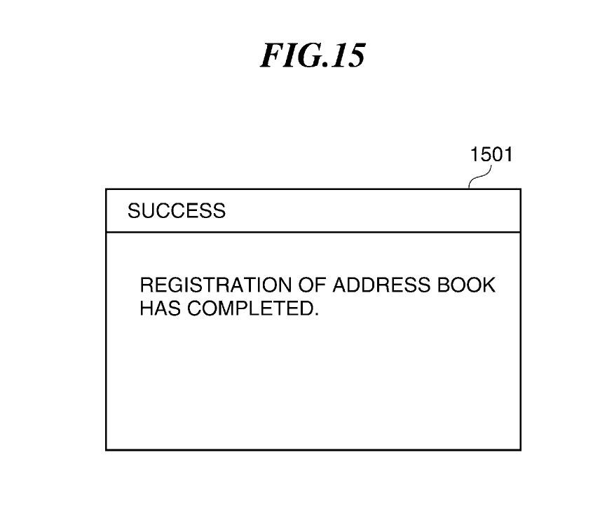

The address book client receives a response from the address book server 105 and determines whether the response means registration success (step S1306). When receiving the response of the registration success, the address book client displays a message showing the registration success as shown in FIG. 15 (step S1309). This displaying process is an example of a first display unit in this embodiment.

When receiving the response that means an error of registration (failure of registration) from the address book server 105, the address book client analyzes the error (step S1307). Then, the address book client displays a message (an error message) corresponding to contents of the error (step S1308). This displaying process is an example of a second display unit in this embodiment.

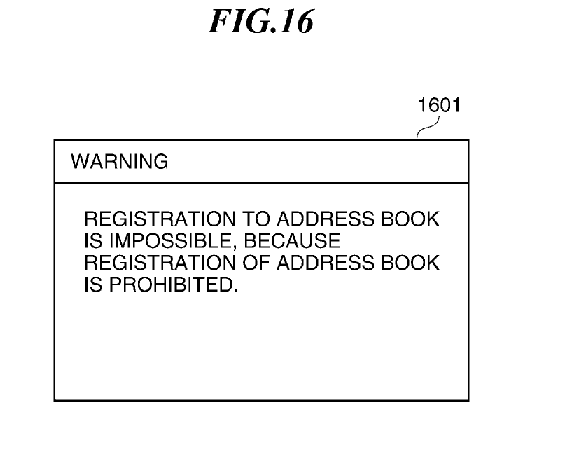

For example, when the address book server 105 is set to prohibit the registration of the address book in the screen 1201 in FIG. 12, a message as shown in a screen 1601 in FIG. 16 is displayed.

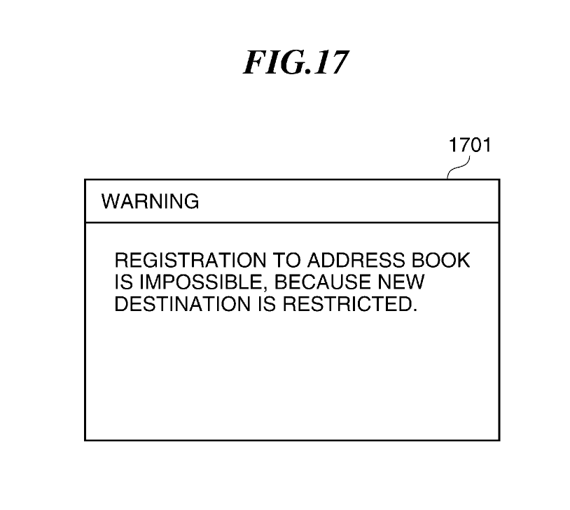

When the address book server 105 is set to restrict the registration of a new destination in the screen 501 in FIG. 5 and when the address book data to be registered is an address of a new destination, a message as shown in a screen 1701 in FIG. 17 is displayed.

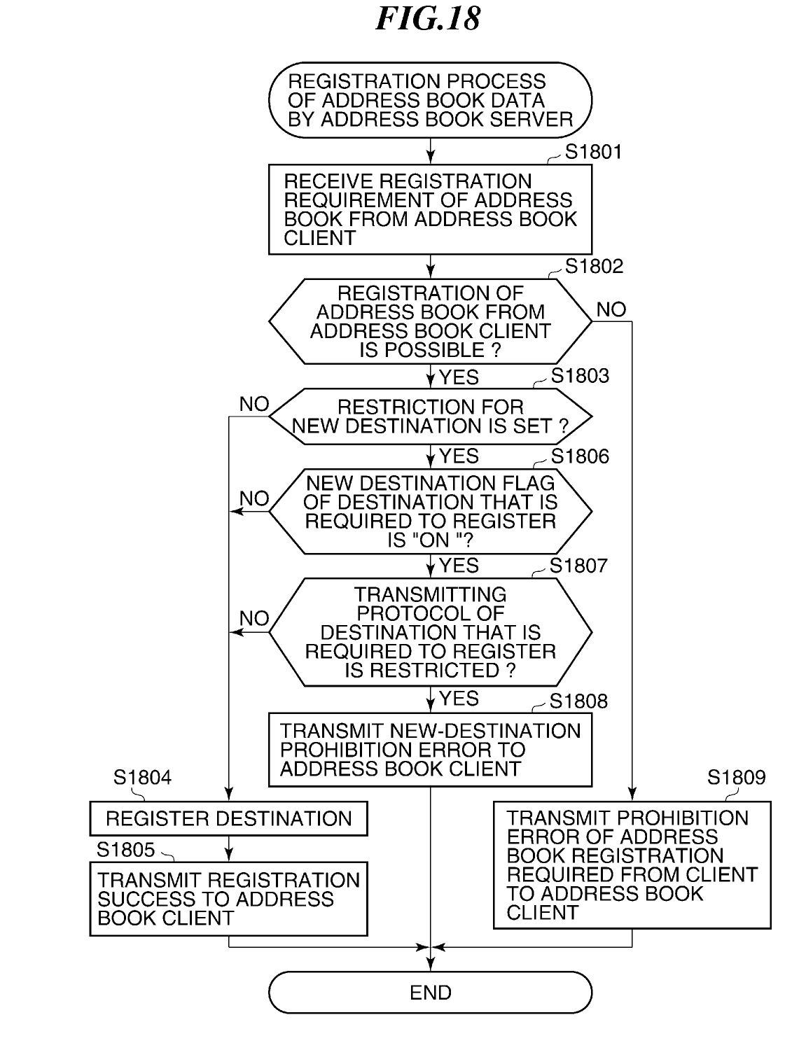

FIG. 18 is a flowchart showing procedures of a registration process that is executed by the address book server to register the address book data when the address book data is registered to the address book server from the address book client 103 or the address book client 104 in FIG. 1.

The registration process of the address book data by the address book server is executed by the CPU in FIG. 2 or FIG. 3 according to a registration processing recipe of the address book data by the address book server that is a registration processing program of a corresponding address book data.

The address book server 105 receives the registration requirement of the address book data from the address book client (step S1801).

Next, the address book server 105 determines whether the address book server 105 has been set to permit registration of the address book in FIG. 13, (step S1802).

When it is determined that the address book server 105 has been set to prohibit registration of the address book in the step S1802, the address book server 105 returns a registration prohibition error to the address book client (step S1809).

When it is determined that the address book server 105 has been set to permit registration of the address book in the step S1802, the address book server 105 determines whether restriction for a new destination in FIG. 5 is set (step S1803). This determination process is an example of a second determination unit in this embodiment.

When it is determined that the restriction has not been set in the step S1803, the address book server 105 registers the address book data transmitted from the address book client into the address book (step S1804).

When the registration of the address book is completed, the address book server 105 returns the registration success to the address book client (step S1805).

When it is determined that a new destination is restricted in the step S1803, the address book server 105 analyzes the flag 1401 that shows a new destination in the address book data transmitted from the address book client (step S1804). The address book server 105 determines whether the destination that is required to register has been registered as a new destination (step S1806). This determination process is an example of a third determination unit in this embodiment.

When it is determined that the destination that is required to register is not address book data that is registered as a new destination in the step S1806, the address book server 105 registers the destination into the address book (step S1804), and returns the registration success to the address book client (step S1805).

When it is determined that the destination that is required to register is address book data that is registered as a new destination in the step S1806, the address book server 105 refers to the data 1402 of the address book data. Then, the address book server 105 determines whether the transmitting protocol restricts registration of a new destination in FIG. 5 (step S1807). This determination process is an example of a fourth determination unit in this embodiment.

When it is determined that the transmitting protocol is not restricted in the step S1807, the address book server 105 registers the destination that is required to register into the address book (step S1804), and returns the registration success to the address book client (step S1805).

When it is determined that the transmitting protocol is restricted in the step S1807, the address book server 105 returns a new-destination prohibition error to the address book client (step S1808).

The present invention restricts improper registration of the address book data from the address book client that occurs when the address book server restricts a new destination input and the address book client does not restrict a new destination input. This is able to improve security.

Since the address book data registered from the address book registration screen becomes possible to register into the address book server, it does not reduce a user's operability.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-155254, filed on Jun. 30, 2009, which is hereby incorporated by reference herein in its entirety.

What is claimed is:

1. An information processing apparatus comprising:
a registration unit adapted to register a destination into an address book;
a first determination unit adapted to determine whether the destination that is to be registered by said registration unit is a new destination;
an addition unit adapted to add identification information that shows a new destination to the address book when determined as a new destination by said first determination unit; and
a requirement unit adapted to require transmitting and registering the address book data to another information processing apparatus.

2. The information processing apparatus according to claim 1, further comprising:
a first display unit adapted to display a message showing registration success when the registration has succeeded corresponding to the requirement of registration from said requirement unit; and
a second display unit adapted to display an error message when the registration has failed corresponding to the requirement of registration from said requirement unit.

3. An information processing apparatus comprising:
a registration unit adapted to register a destination into an address book;
a receiving unit adapted to receive address book data from another information processing apparatus;
a second determination unit adapted to determine whether registration of a new destination is restricted when registering the address book; and
a third determination unit adapted to determine whether identification information that shows a new destination is added to the address book data received by said receiving unit, when said second determination unit determines that the registration of a new destination is restricted,
wherein said registration unit registers the address book data, when said third determination unit determines that the identification information that shows a new destination is not added to the address book data concerned.

4. The information processing apparatus according to claim 3, further comprising:
a fourth determination unit adapted to determine whether the address book data received is data of a transmitting protocol that restricts registration of a new destination; and
a prohibition unit adapted to prohibit registration of the address book data, when said fourth determination unit determines that the address book data received is data of the transmitting protocol that restricts registration of a new destination.

5. A control method for an information processing apparatus comprising:
a registration step of registering a destination into an address book;
a first determination step of determining whether the destination that is to be registered in said registration step is a new destination;
an addition step of adding identification information that shows a new destination to the address book when determined as a new destination in said first determination step; and
a requirement step of requiring transmitting and registering the address book data to another information processing apparatus.

6. A control method for an information processing apparatus comprising:
a registration step of registering a destination into an address book;
a receiving step of receiving address book data from another information processing apparatus;
a second determination step of determining whether registration of a new destination is restricted when registering the address book; and
a third determination step of determining whether identification information that shows a new destination is added to the address book data received in said receiving step, when it is determined that the registration of a new destination is restricted in said second determination step,
wherein the address book data is registered in said registration step, when it is determined that the identification information that shows a new destination is not added to the address book data concerned in said third determination step.

7. A computer-readable storage medium storing a control program executing a control method for an information processing apparatus, the control method comprising:
a registration step of registering a destination into an address book;
a first determination step of determining whether the destination that is to be registered in said registration step is a new destination;
an addition step of adding identification information that shows a new destination to the address book when determined as a new destination in said first determination step; and
a requirement step of requiring transmitting and registering the address book data to another information processing apparatus.

8. A computer-readable storage medium storing a control program executing a control method for an information processing apparatus, the control method comprising:
a registration step of registering a destination into an address book;
a receiving step of receiving address book data from another information processing apparatus;
a second determination step of determining whether registration of a new destination is restricted when registering the address book; and
a third determination step of determining whether identification information that shows a new destination is added to the address book data received in said receiving step, when it is determined that the registration of a new destination is restricted in said second determination step,
wherein the address book data is registered in said registration step, when it is determined that the identification information that shows a new destination is not added to the address book data concerned in said third determination step.
